(19) United States
(12) Patent Application Publication
(10) Pub. No.: US 2024/0249160 A1
(43) Pub. Date: Jul. 25, 2024

(54) PREDICTION APPARATUS, PREDICTION METHOD AND PREDICTION PROGRAM

(71) Applicant: Nippon Telegraph and Telephone Corporation, Tokyo (JP)

(72) Inventor: Takeoki LE, Musashino-shi, Tokyo (JP)

(21) Appl. No.: 18/578,044

(22) PCT Filed: Jul. 30, 2021
(86) PCT No.: PCT/JP2021/028360

§ 371 Date: Jan. 10, 2024

(51) Int. Cl. G06N 5/022

(52) U.S. Cl. CPC G06N 5/022

(57) ABSTRACT

A prediction device for predicting a workload of a server includes: a discrimination unit discriminating whether a variation pattern in the workload over time is only a linear pattern, only a non-linear pattern, or a linear/non-linear pattern in which the linear pattern and the non-linear pattern are mixed; and a prediction unit selecting a plurality of prediction models for linearity when the variation pattern is only the linear pattern, selecting a plurality of prediction models for non-linearity when the variation pattern is only the non-linear pattern, selecting the prediction model for linearity and the prediction model for non-linearity when the variation pattern is the linear/non-linear pattern, and deriving a future prediction value for the workload by performing an ensemble prediction combining the selected plurality of prediction models.

### TECHNICAL FIELD

The present invention relates to a prediction device, a prediction method, and a prediction program.

### BACKGROUND ART

In the cloud expanding their application areas, necessary resources are allocated in advance on the basis of a prediction result of workloads of servers. When a linear or a non-linear characteristic of the workload varies over time, a prediction value of the workload is calculated using a prediction model for calculating the prediction value.

For example, a prediction method using the single prediction model corresponding to a classification result of a variation pattern of the workload is disclosed (Non Patent Literature 1). In addition, the prediction method using an ensemble prediction that combines a plurality of single prediction models by considering the linear and the non-linear characteristics included in the variation pattern is disclosed (Non Patent Literature 2).

### CITATION LIST

### Non Patent Literature

Non Patent Literature 1: C. Liu, and five others, “An adaptive prediction approach based on workload pattern discrimination in the cloud”, Journal of Network and Computer Applications 80, February 2017, p. 35-p. 44
Non Patent Literature 2: B. Liu, and two others, “Quantitative workload analysis and prediction using Google cluster traces”, IEEE Conference on Computer Communications Workshops (INFOCOM), p. 935-p. 940

### SUMMARY OF INVENTION

### Technical Problem

The method in Non Patent Literature 2 improves the method in Non Patent Literature 1 using only single prediction models. However, since the ensemble prediction in Non Patent Literature 2 predicts the workload always by combining the single prediction models corresponding to the respective linear and non-linear characteristics, the prediction value depends on an average of the both characteristics and an optimum prediction value cannot be derived.

The present invention has been made in view of the above problems, and an object of the present invention is to provide a technique capable of improving accuracy of the ensemble prediction of the workload.

### Solution to Problem

A prediction device predicting a workload of a server according to an aspect of the present invention includes: a discrimination unit discriminating whether a variation pattern in the workload over time is only a linear pattern, only a non-linear pattern, or a linear/non-linear pattern in which the linear pattern and the non-linear pattern are mixed; and a prediction unit selecting a plurality of prediction models for linearity when the variation pattern is only the linear pattern, selecting a plurality of prediction models for non-linearity when the variation pattern is only the non-linear pattern, selecting the prediction model for linearity and the prediction model for non-linearity when the variation pattern is the linear/non-linear pattern, and deriving a future prediction value for the workload by performing an ensemble prediction combining the selected plurality of prediction models.

A method of prediction using a prediction device predicting a workload of a server according to an aspect of the present invention includes the steps of: discriminating whether a variation pattern in the workload over time is only a linear pattern, only a non-linear pattern, or a linear/non-linear pattern in which the linear pattern and the non-linear pattern are mixed; and selecting a plurality of prediction models for linearity when the variation pattern is only the linear pattern, selecting a plurality of prediction models for non-linearity when the variation pattern is only the non-linear pattern, selecting the prediction model for linearity and the prediction model for non-linearity when the variation pattern is the linear/non-linear pattern, and deriving a future prediction value for the workload by performing an ensemble prediction combining the selected plurality of prediction models.

Preferably, a computer program according to an aspect of the present invention is configured to cause a computer to perform a predicting function of the prediction device.

### Advantageous Effects of Invention

According to the present invention, it is possible to provide a technique capable of improving the accuracy of the ensemble prediction of the workload.

### BRIEF DESCRIPTION OF DRAWINGS

FIG. 1 is a diagram illustrating a functional block configuration of a prediction device.

FIG. 2 is a diagram illustrating a processing flow of the prediction device.

FIG. 3 is a diagram illustrating an example of a workload.

FIG. 4 is a diagram illustrating an example of a correspondence relationship between a scaling index and a prediction mode.

FIG. 5 is a diagram illustrating examples of prediction models corresponding to each prediction mode.

FIG. 6 is a diagram illustrating a hardware configuration of the prediction device.

### DESCRIPTION OF EMBODIMENTS

Hereinafter, an embodiment of the present invention will be described with reference to the drawings. In the drawings, the same parts are denoted by the same reference signs, and the description thereof is omitted.

### SUMMARY OF INVENTION

In order to solve the above problem, the present invention discloses a prediction device that classifies a variation pattern of a workload into only a linear pattern, only a non-linear pattern, or a linear/non-linear pattern in which the linear pattern and the non-linear pattern are mixed, and performs an ensemble prediction in which a plurality of prediction models in a classified prediction mode are combined. Since the variation pattern of the workload is classified in advance, it is possible to improve the accuracy of the ensemble prediction of the workload.

### [Configuration of Prediction Device]

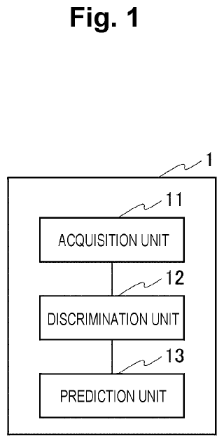

FIG. 1 is a diagram illustrating a functional block configuration of a prediction device 1 according to the present embodiment. The prediction device 1 is a prediction device that performs an ensemble prediction of a workload of a server. The prediction device 1 includes an acquisition unit 11 that acquires the workload, a discrimination unit 12 that performs linear/non-linear discrimination of the workload, and a prediction unit 13 that performs the ensemble prediction of the workload.

The acquisition unit 11 has the function of acquiring the workload of the server. The workload means a magnitude of a processing load of the computer, such as a central processing unit (CPU) usage rate, a memory usage rate, and the number of simultaneous connections.

The discrimination unit 12 has the function of discriminating the variation pattern of the workload. Specifically, the discrimination unit 12 discriminates and determines whether the variation pattern in the workload over time is only a linear pattern, only a non-linear pattern, or a linear/non-linear pattern in which the linear pattern and the non-linear pattern are mixed.

In addition, the discrimination unit 12 has the function of selecting the prediction mode on the basis of the discrimination result of the variation pattern of the workload. Specifically, the discrimination unit 12 selects a linear mode in a case where the variation pattern in the workload over time is only the linear pattern, selects a non-linear mode in the case where the temporal variation pattern is only the non-linear pattern, and selects a mixed mode in the case where the temporal variation pattern is the linear/non-linear pattern.

The prediction unit 13 has the function of selecting at least two or more prediction models from among the plurality of prediction models corresponding to the prediction mode selected by the discrimination unit 12. Specifically, the prediction unit 13 selects a plurality of prediction models for linearity in the case of the linear mode, selects a plurality of prediction models for non-linearity in the case of the non-linear mode, and selects the prediction model for linearity and the prediction model for non-linearity in the case of the mixed mode.

In addition, the prediction unit 13 has the function of deriving a future prediction value of the workload acquired by the acquisition unit 11 by performing the ensemble prediction in which the plurality of prediction models are combined by adjusting each weight in consideration of a trade-off between the plurality of selected prediction models.

### [Operation of Prediction Device]

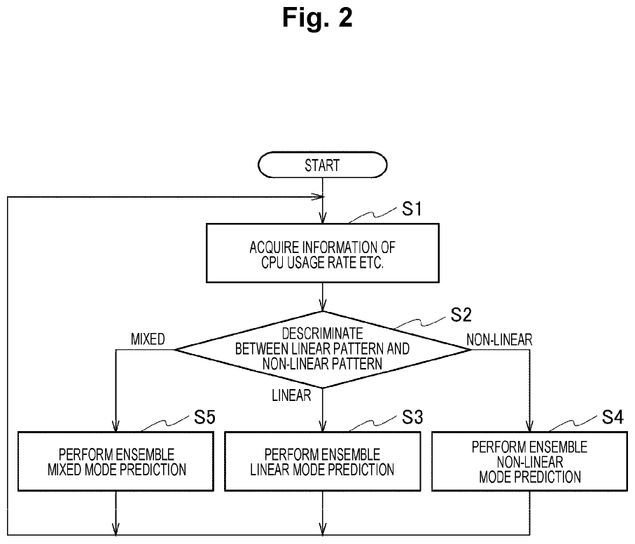

FIG. 2 is a diagram illustrating a processing flow of the prediction device 1.

### Step S1;

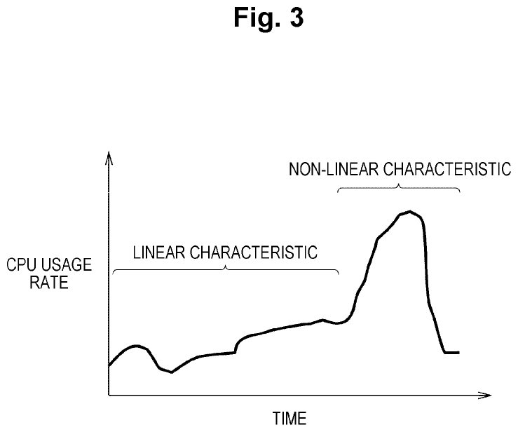

The acquisition unit 11 acquires the workload recorded in a log data of an operating server from the operating server operating in the cloud. An example of the workload is illustrated in FIG. 3.

### Step S2;

Then, the discrimination unit 12 discriminates whether the variation pattern (variation/change tendency of a parameter value such as the CPU usage rate) in the workload over time acquired from the operating server is only the linear pattern, only the non-linear pattern, or the linear/non-linear pattern in which the linear pattern and the non-linear pattern are mixed.

For example, the variation pattern is discriminated using a variation pattern analysis method based on a detrended fluctuation analysis (DFA) method according to a document entitled “A Self-Organizing Approach to Measuring Long-Range Dependence in IP Traffic using Detrended Fluctuation Analysis” by Masugi at The Third Forum on Information Technology 2004 (FIT 2004) (L-034, pp. 91 to 92).

First, new time-series data y(k) is defined as described in Formula (1), where the time-series data of the workload is x(i) {i=1, 2, . . . , N} and an overall average of the time-series data is x {“−” above x} (Discrimination Procedure 1).

### [Math. 1]

$$y ( k ) = {\sum }_{i = 1}^{k} \{ x ( i ) - \overline{x} \} \qquad Formula ( 1 )$$

Next, the new time-series data y(k) is divided into sections at equal intervals n, and then a local trend yₙ(k) is derived by least squares method approximation within each section (Discrimination Procedure 2). Then, as described in Formula (2), a square root F(n) of the mean square for the given all-period scale n is derived (Discrimination Procedure 3).

### [Math. 2]

$$F ( n ) = {[ \frac{1}{n} {\sum }_{k = 1}^{N} {\{ y ( k ) - {y}_{n} ( k ) \}}^{2} ]}^{1 / 2} \qquad Formula ( 2 )$$

Next, a scaling index α is defined as a slope of a straight line portion of the graph of “log n−log F(n)” (Discrimination Procedure 4). Finally, the variation pattern is discriminated as the non-linear pattern when the scaling index α is within a range of about 0.0 to about 0.5, discriminated as the linear pattern when the scaling index α is within the range of about 0.5 to about 1.5, and discriminated as the linear/non-linear pattern when the scaling index α is a value other than these ranges (Discrimination Procedure 5).

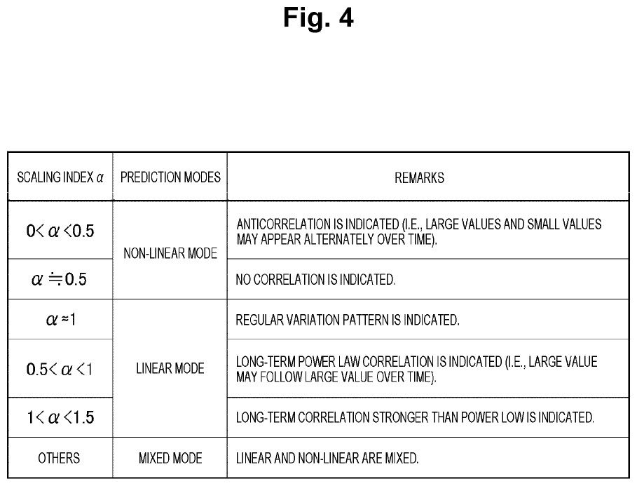

After the linear/non-linear discrimination of the workload is performed, the discrimination unit 12 selects the linear mode as the prediction mode when discriminating that the variation pattern in the workload over time is the linear pattern, selects the non-linear mode as the prediction mode when discriminating that the temporal variation pattern is the non-linear pattern, and selects the mixed mode as the prediction mode when discriminating that the temporal variation pattern is the linear/non-linear pattern. FIG. 4 illustrates an example of a correspondence relationship between the scaling index and the prediction mode.

### Step S3;

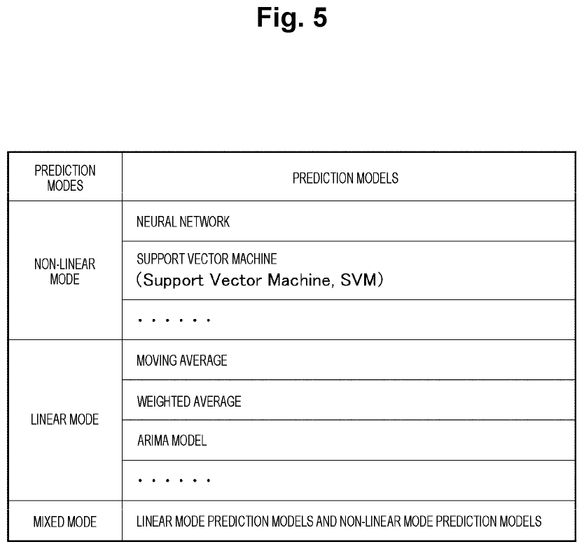

Next, when the prediction mode selected by the discrimination unit 12 is the linear mode, the prediction unit 13 selects at least two or more prediction models from among the plurality of prediction models corresponding to the linear mode (e.g., a moving average, a weighted average, an auto regressive integrated moving average (ARIMA) model, and a linear regression model). FIG. 5 illustrates examples of the prediction models corresponding to each prediction mode.

Then, the prediction unit 13 derives the future prediction value of the workload by performing the ensemble prediction in which the plurality of prediction models are combined by adjusting each weight in consideration of the trade-off between the plurality of selected prediction models. A method of calculating the ensemble prediction will be described later.

### Step S4;

Next, when the prediction mode selected by the discrimination unit 12 is the non-linear mode, the prediction unit 13 selects at least two or more prediction models from among the plurality of prediction models corresponding to the non-linear mode (e.g., a neural network and a non-linear support vector machine (SVM) model) (see FIG. 5).

Then, the prediction unit 13 derives the future prediction value of the workload by performing the ensemble prediction in which the plurality of prediction models are combined by adjusting each weight in consideration of the trade-off between the plurality of selected prediction models. The method of calculating the ensemble prediction will be described later.

### Step S5;

Next, when the prediction mode selected by the discrimination unit 12 is the mixed mode, the prediction unit 13 selects at least two or more prediction models for each mode from among the plurality of prediction models corresponding to the linear mode (e.g., a moving average, a weighted average, and an ARIMA model) and the plurality of prediction models corresponding to the non-linear mode (e.g., a neural network and a non-linear SVM model) (see FIG. 5).

Then, the prediction unit 13 derives the future prediction value of the workload by performing the ensemble prediction in which the plurality of prediction models are combined by adjusting each weight in consideration of the trade-off between the plurality of selected prediction models.

Finally, the method of calculating the ensemble prediction will be described.

As described in Formula (3), the prediction value y(i) {“\hat{ }” above y} by the ensemble prediction for the i-th time slot indicating future time is calculated such that a different weight for each prediction model wₘ(i) is applied to the prediction value pₘ(i) {“\hat{ }” above p} calculated using the m-th prediction model among total number M of prediction models, pₘ(i) and wₘ(i) are multiplied, and the total number M of multiplied values are summed.

### [Math. 3]

$$\hat{y} ( i ) = {\sum }_{m = 1}^{M} {w}_{m} ( i ) \times {\hat{p}}_{m} ( i ) \qquad Formula ( 3 )$$

Note that the sum of all the total number M of weights in the i-th time slot is 1. In addition, the all initial values of the weights for the prediction values calculated using the respective prediction models are set to the same value (i.e., 1/M). Furthermore, in the (i+1)-th time slot, the m-th weight wₘ(i+1) is calculated by Formula (4) including an i-th prediction error eₘ(i) as a variable.

### [Math. 4]

$${w}_{m} ( i + 1 ) = \frac{1 - {e}_{m} ( i )}{{\sum }_{m = 1}^{M} ( 1 - {e}_{m} ( i ) )} \qquad Formula ( 4 )$$

$$here ,$$

$${e}_{m} ( i ) = ( y ( i ) - \hat{y} ( i ) ) / y ( i )$$

After step S5, the future prediction value of the workload of the operating server acquired in step S1 is output on the display. For example, the prediction value of the CPU usage rate after 10 minutes and the prediction value of the memory usage rate after 10 minutes or 1 hour are output. The administrator of the operating server can determine whether to increase or decrease necessary resources (e.g., the number of servers, CPU, memory, and communication interface) by utilizing the prediction value of the workload.

### [Effects]

Since the prediction device 1 predicting the workload of the server includes: the discrimination unit 12 discriminating whether the variation pattern in the workload over time is only the linear pattern, only the non-linear pattern, or the linear/non-linear pattern in which the linear pattern and the non-linear pattern are mixed; and the prediction unit 13 selecting the plurality of prediction models for linearity when the variation pattern is only the linear pattern, selecting the plurality of prediction models for non-linearity when the variation pattern is only the non-linear pattern, selecting the prediction model for linearity and the prediction model for non-linearity when the variation pattern is the linear/non-linear pattern, and deriving the future prediction value for the workload by performing the ensemble prediction combining the selected plurality of prediction models, the present embodiment can provide a technique capable of improving the accuracy of the ensemble prediction of the workload.

### [Others]

The present invention is not limited to the above-described embodiment. The present invention can be modified in various manners within the gist of the present invention.

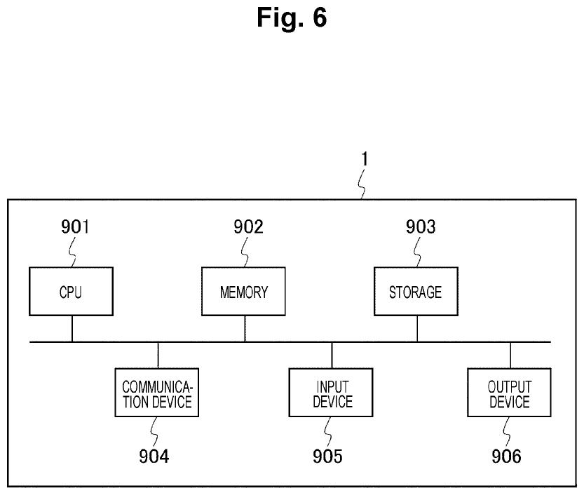

The prediction device 1 of the present embodiment described above can be implemented using, for example, a general-purpose computer system including a CPU 901, a memory 902, a storage 903, a communication device 904, an input device 905, and an output device 906 as illustrated in FIG. 6. The memory 902 and the storage 903 are storage devices. In the computer system, each function of the prediction device 1 is implemented by the CPU 901 executing a predetermined program loaded on the memory 902.

The prediction device 1 may be implemented by a single computer. The prediction device 1 may be implemented by a plurality of computers. The prediction device 1 may be a virtual machine implemented in a computer. The program for the prediction device 1 can be stored in a computer-readable storage medium such as an HDD, an SSD, a USB memory, a CD, or a DVD. The program for the prediction device 1 can also be distributed via a communication network.

### REFERENCE SIGNS LIST

1 Prediction device
11 Acquisition unit
12 Discrimination unit
13 Prediction unit
901 CPU
902 Memory
903 Storage
904 Communication device
905 Input device
906 Output device

1. A prediction device predicting a workload of a server, the prediction device comprising:
a discrimination unit, comprising one or more processors, configured to discriminate whether a variation pattern in the workload over time is only a linear pattern, only a non-linear pattern, or a linear/non-linear pattern in which the linear pattern and the non-linear pattern are mixed; and
a prediction unit, comprising one or more processors, configured to select a plurality of prediction models for linearity when the variation pattern is only the linear pattern, select a plurality of prediction models for non-linearity when the variation pattern is only the non-linear pattern, select the prediction model for linearity and the prediction model for non-linearity when the variation pattern is the linear/non-linear pattern, and derive a future prediction value for the workload by performing an ensemble prediction combining the selected plurality of prediction models.

2. The prediction device of claim 1, wherein the prediction unit is configured to apply different weights to the plurality of prediction models respectively, and perform the ensemble prediction.

3. A method of prediction using a prediction device predicting a workload of a server, the method comprising
discriminating whether a variation pattern in the workload over time is only a linear pattern, only a non-linear pattern, or a linear/non-linear pattern in which the linear pattern and the non-linear pattern are mixed; and
selecting a plurality of prediction models for linearity when the variation pattern is only the linear pattern, selecting a plurality of prediction models for non-linearity when the variation pattern is only the non-linear pattern, selecting the prediction model for linearity and the prediction model for non-linearity when the variation pattern is the linear/non-linear pattern, and deriving a future prediction value for the workload by performing an ensemble prediction combining the selected plurality of prediction models.

4. A non-transitory computer readable medium storing a computer program, wherein execution of the program causes a computer to perform a predicting function of the prediction device of claim 1.
